(19) United States
(12) Patent Application Publication
(10) Pub. No.: US 2013/0226607 A1
(43) Pub. Date: Aug. 29, 2013

(54) AUTOMATED HEALTH CARE DELIVERY VERIFICATION

(71) Applicant: Assura Technology Group, LLC, (US)

(72) Inventors: William F. Woody, Missoula, MT (US); Daryl M. Holzer, Missoula, MT (US); Ronald S. Dunbar, Missoula, MT (US); Joseph R. Ogg, Missoula, MT (US); John C. Stewart, Stevensville, MT (US); Bradley J. Monahan, Missoula, MT (US); Benjamin E. Bledsoe, Missoula, MT (US); Mickey K. Ogg, Missoula, MT (US); Bruce A. Kramer, Missoula, MT (US); Tracey E. Spoonemore, Billings, MT (US); Kevin M. Rose, Tacoma, WA (US); Mark H. Mason, Seattle, WA (US); Zachery D. Bates, Issaquah, WA (US); Joel D. Wetzel, North Bend, WA (US); Michael JC Brown, Renton, WA (US); Melinda L. DeMars, Newcastle, WA (US)

(73) Assignee: ASSURA TECHNOLOGY GROUP, LLC, Missoula, MT (US)

(21) Appl. No.: 13/779,757

(22) Filed: Feb. 28, 2013

Related U.S. Application Data
(60) Provisional application No. 61/603,961, filed on Feb. 28, 2012.

(51) Int. Cl. G06Q 10/06; G06Q 50/22

(52) U.S. Cl. CPC G06Q 10/063114; G06Q 50/22
USPC 705/2

(57) ABSTRACT

A health service system is described herein that uses commonly available modern mobile computing devices to enhance the delivery and verification of health care services. Information automatically collected from mobile devices can corroborate a timesheet, mileage log, or other information submitted by caregivers. The system provides a comprehensive suite of verification technologies. For example, the system may capture photographic evidence of the visit (e.g., a picture of the patient, caregiver, or both together), GPS location and time information, biometric information (e.g., a fingerprint, retina scan, or other biometric signature from the patient and/or caregiver), and so forth. Thus, the health service system improves the delivery of and payment for health care services by helping each party to collect and provide the information associated with verification in a less obtrusive and more automated manner.

### CROSS-REFERENCE TO RELATED APPLICATIONS

The present application claims the benefit of U.S. Provisional Patent Application No. 61/603,961 (Attorney Docket No. WOODY001) entitled “AUTOMATED HEALTH CARE DELIVERY VERIFICATION,” and filed on Feb. 28, 2012, which is hereby incorporated by reference.

### BACKGROUND

Health care today is a huge business that encompasses a wide variety of services, including hospital care, in-home care, and prescription drug delivery. Services are often paid for by a variety of entities other than the patient, including federal and state governments (e.g., Medicaid, veterans' benefits), pension plans, private health insurance companies, and so forth. Health care may include one-time incidents, such as care for an injury, as well as ongoing management of chronic conditions. Conditions may include those that occur after an injury, chronic diseases such as diabetes, age-related illnesses, and many others. The type of care delivered to patients or clients by a health care service entity and associated caregivers may range from delivering medications to performing physical therapy, to providing baths and other day-to-day help to patients whose conditions make it difficult for them to perform these tasks on their own.

As a condition of payment for various services, entities paying for health care services often request various levels of verification that the service was performed. Verification may include confirming that the service was performed on the intended client, by the indicated service provider, that the correct service was performed, that the service was authorized, that the service took place at the intended time, and so forth. Today, this is performed by caregivers keeping timesheets, mileage logs, obtaining patient signatures indicating that services were performed, and by other manual means.

Unfortunately, it is often difficult to verify that services were actually performed in accordance with expectations of the payer and to appropriate standards. Fraud is a major concern of payers for health care services, and the amount of money flowing into healthcare services from entities other than the caregiver and patient create an environment where fraud is both lucrative and difficult to detect. In response, in recent years payers have gone to greater and greater lengths to ensure that health care services are being delivered in the manner paid for and expected. This may include increasing administrative burden on health care service providers and their associated caregivers to produce additional evidence of services rendered, as well as more physical checks such as random spot checking (e.g., driving by a location where a service is being performed) to catch cases where the paper trail does not match the actual actions performed. Health care service providers have an increased incentive to provide ample verification because evidence of services provided is often a condition of being paid for performing those services.

### BRIEF DESCRIPTION OF THE DRAWINGS

FIG. 1 is a block diagram that illustrates components of the health service system, in one embodiment.

FIG. 2 is a flow diagram that illustrates processing of the health service system to receive care verification information from a mobile device associated with a caregiver, in one embodiment.

FIG. 3 is a flow diagram that illustrates processing of the health service system to analyze information at a health care service provide by one or more mobile devices associated with caregivers, in one embodiment.

FIG. 4 is a flow diagram that illustrates processing of the health service system to provide verification to a health service payer, in one embodiment.

### DETAILED DESCRIPTION

A health service system is described herein that uses commonly available modern mobile computing devices to enhance the delivery, data collection, and verification of health care services. Many people today carry a smartphone, medical data peripheral, or other mobile computing device (e.g., tablet computers, MP3 players, cell phones, and so forth) that is capable of running applications and that includes peripheral hardware that is useful to applications for sensing the environment of the device. For example, many modern smartphones include global positioning system (GPS) radio hardware, cell phone tower triangulation hardware, accelerometers, cameras, biometric sensors, and so forth. These devices and peripheral hardware can be leveraged to provide more automated verification of healthcare services. For example, GPS hardware can be used to verify that a caregiver arrived at a particular location at a particular time, and then left the location at a particular later time. This information can corroborate a timesheet, mileage log, or other information submitted by the caregiver. In some embodiments, the system provides a comprehensive suite of verification technologies. For example, the system may capture photographic evidence of the visit (e.g., a picture of the patient, caregiver, or both together), GPS location and time information, biometric information (e.g., a fingerprint, retina scan, or other biometric signature from the patient and/or caregiver), and so forth. Thus, the health service system improves the delivery of and payment for health care services by helping each party to collect and provide the information associated with verification in a less obtrusive and more automated manner.

In some embodiments, the health service system includes a service component that communicates with client computing devices associated with caregivers to provide various server side verification and analysis. For example, the service can look for anomalies such as a caregiver reporting services rendered at two locations at the same time, traveling between two remote locations in faster than possible time, and so forth. The service may also perform more computationally intensive tasks that are less well suited to some mobile devices, such as facial recognition (e.g., of patients and/or caregivers). The service may include one or more backend servers, data centers, cloud-based services, and so forth that implement at least one endpoint to which a mobile device can report information.

In some embodiments, the service and client work together to provide additional facilities for verifying the caregiver's activities with respect to the patient. For example, the service may send a challenge via a text message (e.g., short message service (SMS)), an in-application message, email message, push notification, or other alert that asks the caregiver to provide a particular response in a certain amount of time (e.g., a response text in five minutes). If the caregiver fails to respond, then the system may flag the caregiver for additional monitoring. If the caregiver provides the expected response, then the system adds this information to the evidence collected to verify the caregiver's activities and services rendered to the patient. As indicated in this example, the system can dynamically scale up and down the level of verification challenges provided to each caregiver based on a past level of reliability and trust established by the caregiver. One type of challenge may ask the caregiver to send a picture of the caregiver and client together within the next five minutes. This type of challenge verifies that the caregiver is in possession of his/her device, that the caregiver is with the indicated client, and that the caregiver was present at the appointed time to be able to take the requested photo. In some cases the caregiver may have reason to delay (e.g., perhaps the caregiver is in the middle of providing a difficult service), and the system may provide a “snooze” or similar function that allows the caregiver to respond to a later challenge or defer responding to the current one without an immediate penalty.

In some embodiments, the service component of the health service system includes a web portal and rules engine. The web portal can provide access to caregivers through mobile devices (e.g., via a web browser) to submit and access patient information and to service payers to verify services are performed and to provide payment. The system may provide authorization specifying who can access and contribute to particular patient information. The rules engine can perform a variety of functions, including managing particular workflows associated with each service to ensure that required steps are taken, that optional steps are recorded when performed, and so forth. In some embodiments, the rules engine manages authorizations from payers for particular services to be delivered to patients. The rules engine can also manage dynamic verification as described herein and can analyze received verification and other information for anomalies, errors, omissions, and so forth.

In some embodiments, the health service system also captures patient wellness information. For example, the system may capture patient heart rate, blood pressure, blood sugar, or other information using a mobile device associated with a caregiver or information entered by the caregiver. The system also works with third party health data collection peripherals. The service component can analyze the information to identify anomalies, such as values outside of a threshold, and can alert the caregiver of potential problems or additional needed services for the patient.

The health service system can operate in a variety of automated and semi-automated modes. For example, some mobile devices allow geofences to be set up that wake the device when the device arrives at a particular location. In such cases, the device may automatically wake up from a sleep or standby state when the caregiver arrives at a patient's location, detect various activities or information associated with the caregiver's presence at the patient's location, note when the caregiver leaves, and then report the collected information to the service for further processing. In other cases, the system may operate when a caregiver launches an application on a mobile device, at which time the device may collect GPS information, patient information, and so forth. The application may determine, based on the location, which patient the caregiver is visiting, which services are to be performed, and so forth. In this way, the application can present a user interface to the caregiver for recording particular information related to the visit and verification of the services performed.

The health service system can operate with a real-time network connection or in an offline capacity. In some cases, the mobile device may have a readily available Internet or other network connection such that the mobile device and applications running on it can transmit collected information to a service in real time as the information is collected. In other cases, such as when a caregiver is visiting a remote or rural location, the device may not have a persistent connection, but can still collect information for later uploading or synchronizing with the backend service. The system may also defer challenges or other fraud detection techniques described herein until the device is connected again.

In some embodiments, the health service system uses the mobile device and/or other hardware to capture a complete log of the visit. For example, the device's camera, microphone, or advanced peripherals such as Microsoft's Kinect controller can be used to capture input information during the duration of the visit with the patient. Privacy is an important concern in the health field and thus the system may limit the amount of potentially sensitive information captured. Devices like the Kinect controller allow the capture of a good sense of where the caregiver was and what he/she was doing without capturing potentially embarrassing or private data related to the patient.

In some embodiments, the health service system leverages near field communication (NFC) devices to provide additional input to the system. For example, a patient's house can be outfitted with NFC devices at various locations where services are performed, like a kitchen where meals are prepared or a bathtub where baths are given. The caregiver may then be asked to “bump” his/her mobile device at each location when a service start or ends. This verifies that not only was the caregiver at the appointed location, but that the caregiver also went around the location to various sub-locations performing assigned services. As another example of NFC, the caregiver may be asked to bump his/her mobile device to a client's mobile device to verify presence with the client. In some embodiments, the system attempts to balance convenience of the caregiver with the expectation of payers that evidence of services be collected. Thus, the system may attempt to capture as much information as possible in an automated fashion without interrupting the caregiver. Even though less burden is placed on the caregiver, the system can still capture more information than is available today for providing verification to payers.

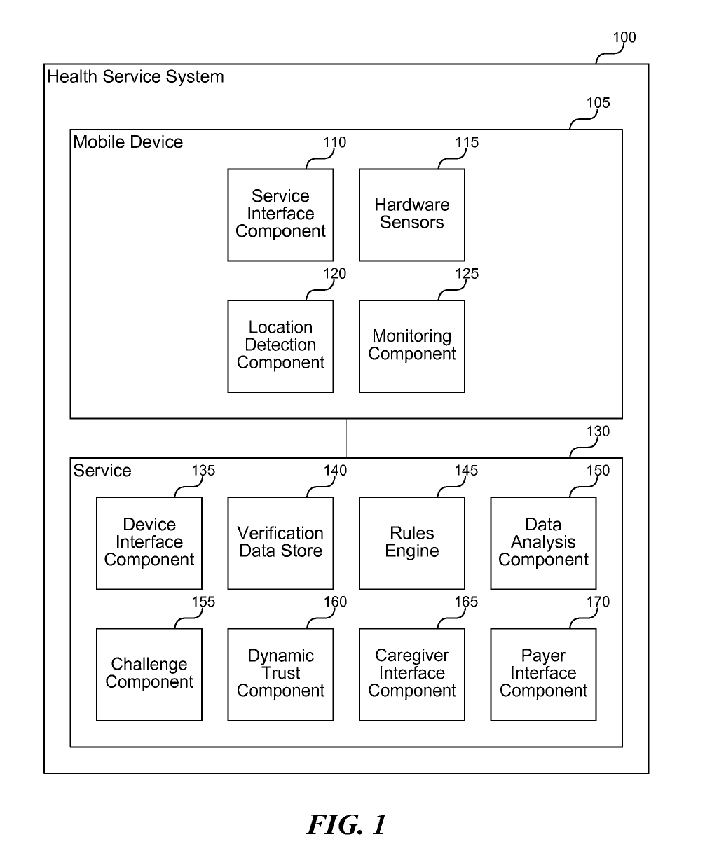

FIG. 1 is a block diagram that illustrates components of the health service system, in one embodiment. The system 100 includes one or more mobile devices like mobile device 105 and a service 130. Although various components are described below as part of the mobile device 105 or service 130, those of ordinary skill in the art will recognize that components can be rearranged and may be present at either or both locations. For example, although the data analysis component 150 is shown as part of the service 130, the mobile device 105 may also include a data analysis component 150 for performing analysis that can be performed at the mobile device 105. Each of these components is described in further detail herein.

The mobile device 105 may include any one or more types of mobile devices carried by a caregiver in the process of performing healthcare services for a client. For example, the mobile device 105 may include a smartphone, tablet computer, media player, smart watch, or other mobile device. Although described as a single device for ease of explanation, the mobile device 105 may actually include multiple devices each capturing different or redundant types of data related to a client visit and services performed by the caregiver. For example, a particular caregiver may carry a smartphone and a tablet computer, each of which provides data to the service 130 described herein.

The mobile device 105, in some embodiments, includes a service interface component 110, one or more hardware sensors 115, a location detection component 120, and a monitoring component 125. Each of these components is described in further detail herein.

The service interface component 110 communicates between the mobile device 105 and service 130 to send monitoring data captured at the mobile device 105 to the service 130, and to receive challenges, client assignments, and other information from the service 130 for delivery to a caregiver using the mobile device 105. The service interface component 110 may communicate according to any commonly available or proprietary communication model, such as Wi-Fi, cellular, Bluetooth, or other communication standards. In some embodiments, the service interface may include an offline mode that allows a caregiver to use the mobile device 105 with no real-time connectivity. This can be useful, for example, for caregivers working in rural or other low infrastructure areas. The system 100 can nevertheless capture useful monitoring information that can later be transferred from the mobile device 105 to the service 130 upon availability of a connection between the two. The service interface may also include one or more application programming interfaces (APIs) present on the mobile device 105 through which third party or other applications can be used to expand the functionality of the system 100 by sending and receiving additional data to and from the service 130.

The mobile device 105 includes one or more hardware sensors 115 that sample environmental information present around the mobile device 105 during its use. Hardware sensors may include GPS, cellular triangulation, biometric sensors, cameras, facial or eye detection, infrared sensors, accelerometers, tilt sensors, digital compasses, microphones, NFC hardware, clocks, or any other type of sensor that can gather information requested by the service 130 for verification that services are performed and for enhancing the performance of the services. Because different mobile devices may include different sensors, the service 130 may receive different types of monitoring information from one or more mobile devices carried by each caregiver. For example, the service 130 may receive GPS information from a caregiver's smartphone that includes a GPS radio, and textual input from a caregiver's tablet as the caregiver reports on the services rendered or patient/client information.

The location detection component 120 detects a present location of the mobile device 105 at various times based on available hardware sensors for determining location. In recent years, many new techniques for detecting location have been discovered in addition to GPS hardware, such as cellular triangulation, Wi-Fi hotspot triangulation, and potentially new methods in the future. The location detection component 120 can use any and all available location detecting methods to identify course and fine-grained location information associated with a caregiver. For example, while GPS hardware can often give a course grained location within hundreds of feet of accuracy, Wi-Fi hotspot triangulation can often determine which floor of a multiple story building a person is on, which room in a house a person is in, and other fine-grained location information. NFC, Bluetooth, or other near field communication tools may also be used to sample finer grained location information. When delivering health care services and verifying the same, it can be relevant to know whether a caregiver spent a substantial amount of time with a client in a kitchen (e.g., cooking meals) versus a bathroom (e.g., assisting with bathing) versus a bedroom.

The monitoring component 125 collects verification information available from the location detection component 120 and one or more hardware sensors 115 and sends the information using the service interface component 110 to the service 130. The verification information may include any evidentiary information collected that substantiates which services were performed, on which client the services were performed, and by which caregiver the services were performed. For example, the information may include photographs taken by a camera, location information collected from GPS and other sensors, time information from a clock, textual and/or audiovisual information entered by the caregiver, and so on. The monitoring component 125 may periodically send additional information to the service 130 or wait until particular intervals (e.g., after each client call) to provide information to the service 130.

The service 130 may include one or more central servers, datacenters, a cloud-based computing service, and so forth. The service 130 provides a central location where multiple mobile devices, such as mobile device 105, carried by potentially many caregivers can report monitoring data related to services rendered by the caregivers to clients. The service 130 analyzes collected verification data and provides various reports available potentially to caregivers, payers, clients, and an operator of the service 130. Although described as a central service 130, those of ordinary skill in the art will recognize that the service 130 may be physically located at multiple computer systems distributed geographically that act together to service caregivers and clients in various locations. In other words, the service 130 can be a virtual concept potentially made up of many physical servers that are not necessarily at one location.

The service 130 includes a device interface component 135, a verification data store 140, a rules engine 145, a data analysis component 150, a challenge component 155, a dynamic trust component 160, a caregiver interface component 165, and a payer interface component 170. Each of these components is described in further detail herein.

The device interface component 135 communicates with one or more mobile devices, such as mobile device 105, carried by caregivers on client visits to perform healthcare services and receives verification information from the mobile devices that substantiates whether particular services were performed, by which caregiver the services were performed, and on which client's behalf the services were performed. The device interface component 135 may communicate according to any commonly available or proprietary communication model, such as Wi-Fi, cellular, Bluetooth, or other communication standards. In some embodiments, the device interface may include an offline mode that allows a caregiver to use the mobile device 105 with no real-time connectivity and upload information related to potentially multiple client visits later in a batch to the service 130 through the device interface component 135.

The verification data store 140 stores verification information received from mobile devices in one or more storage devices. The data store 140 may include one or more files, file systems, hard drives, storage area networks (SANs), databases, cloud-based storage services, or other storage facilities for persisting data. The stored data may include available service information, client information, caregiver information, payer information, payer-specific rules, results of data analysis, and other information in addition to the verification information received from mobile devices. The verification data store 140 may encompass multiple storage facilities at multiple locations, and multiple instances of data such as backups or redundant data storage techniques.

The rules engine 145 manages rules that express differences and requirements for service verification from each payer for which the system 100 collects verification information. As an example, government payers in each state often have different information requested as proof that a particular service was performed, or other information that they request be collected as part of the services performed. In addition, the rules engine 145 may manage advance authorizations for performing particular services, as well as post-authorizations once verification information is provided that indicates requested conditions have been satisfied.

Some examples of rules for auditing time sheets of caregivers include: recipient name required, caregiver name required, date of service required, services performed required, tasks performed required, mileage card available, time-sheet must have at least one service, time-sheet must have at least one task, all tasks must be selected to claim all hours, only approved tasks can be selected, submission requires a note per shift, submission requires a note per day, submission requires a note for overtime, submission requires a note for unapproved tasks, only caregivers can submit time sheets, service recipient or representative must approve time, only a recipient or representative can approve time, not both, live-in caregiver total hours daily option, frequency of tasks required, hospitalization fields available, time-sheets cannot be submitted during hospitalization, medical escort documentation fields, client has limited approved hours, client has max hours per week over which time cannot be submitted, shifts are defined as contiguous time. Each of these represents a field of information that may or may not be requested by each particular payer and jurisdiction. The rules engine 145 maintains this information generally and for each specific payer so that appropriate verification information is collected by the service 130 related to each client to which services are rendered.

The data analysis component 150 analyzes verification information submitted by mobile devices to identify trends and draw conclusions from the information related to verifying whether healthcare services were performed as requested. For example, the data analysis component 150 can determine from location information collected by mobile devices where a particular caregiver was throughout the day. This information may indicate, for example, that a caregiver stayed too long at a particular client's location or not long enough. In addition, by correlating information from multiple sources, such as from the caregiver's own reports and a mobile device's uploaded information, the component 150 can detect discrepancies to catch either fraud or inadvertent reporting errors. The component 150 may also provide visualization of collected data to provide graphical reporting of verification information. Another type of data analysis that may be performed by the component 150 is facial recognition of people in photos captured by caregiver mobile devices and voice identification of audio data. This can be used to identify the caregiver, client, or other parties in verification photos. The data analysis component 150 stores the result of various analyses in the verification data store 140 for reporting to payers and other actions (such as reviewing caregivers, billing clients, and so forth).

The challenge component 155 optionally provides dynamic challenges to caregivers at particular times, where a challenge represents a tool for determining whether the caregiver is in possession of a particular mobile device at a specific time. One manner in which location-based detection of caregiver location can be circumvented is by giving the caregiver's device to another caregiver or person that goes where the caregiver is supposed to be. This can be detected and prevented by sending the caregiver's mobile device a dynamic challenge that requests that the caregiver provide timely and relevant verification information, such as a photograph of the caregiver with the client. This verifies that not only is the caregiver's device present at the appointed location, but the caregiver is in possession of the device. Challenges may come in the form of an in-application message, email, push notification, text message, or any other form that can be received by the caregiver or mobile device. Responses may include the caregiver pushing a button, entering a passphrase, taking a photo, or collecting any other information that over time is determined to provide a good challenge for verification information about the caregiver.

The dynamic trust component 160 dynamically determines a level of verification to request from a particular caregiver based on a historical pattern of trust established with the caregiver. For example, as a caregiver is more often verified to be at an appointed place performing an appointed service, the system 100 may reduce the amount of verification information requested from the caregiver. For example, the system may collect fewer challenges, ease a reporting burden, and so forth. Where there is flexibility in the information that need be provided to a particular payer, the system 100 has some leeway in what information is collected for the operator of the system's own internal purposes. Some information may always need to be collected, but other information may be omitted where caregivers have proven trustworthy. In contrast to the above example, if a caregiver has been historically less reliable, then the system 100 may scale up the amount of verification requested. For example, the system 100 may issue increased challenges to the caregiver. This process is managed by the dynamic trust component 160. The component 160 may also allow case managers to manually increase or decrease requirements, based on factors within their knowledge.

The caregiver interface component 165 provides one or more user interfaces to caregivers for reporting information and receiving reports associated with the caregiver. For example, the system may provide a timesheet interface through which caregivers can manually enter time spent performing various tasks (in addition to the time information that may be automatically collected by the system 100). In addition, the system 100 may provide various reports to caregivers, such as a summary of client visits, payroll information, a user profile of the caregiver, and so forth. The caregiver interface component 165 may provide one or more web pages, mobile or desktop applications, console user interfaces (CUI), programmatic interfaces, and so forth through which information is provided to caregivers.

The payer interface component 170 provides one or more user interfaces to payers to provide and receive information related to healthcare services rendered by caregivers to clients. The interfaces provides to payers may include interfaces to approve payment requests, interfaces to receive reports providing evidence to substantiate payment requests, interfaces to receive audit rules specific to a particular payer, and so forth. The payer interface provides access to the system 100 for payers to perform tasks relevant to them. Like other interfaces of the system 100, the payer interface component 170 may provide one or more web pages, mobile or desktop applications, console user interfaces (CUI), programmatic interfaces, and so forth through which information is provided to payers. The system 100 may include other interfaces for viewing collected data or other tasks in addition to those detailed here.

The computing device on which the health service system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored on computer-readable storage media. Any computer-readable media claimed herein include only those media falling within statutorily patentable categories. The system may also include one or more communication links over which data can be transmitted. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

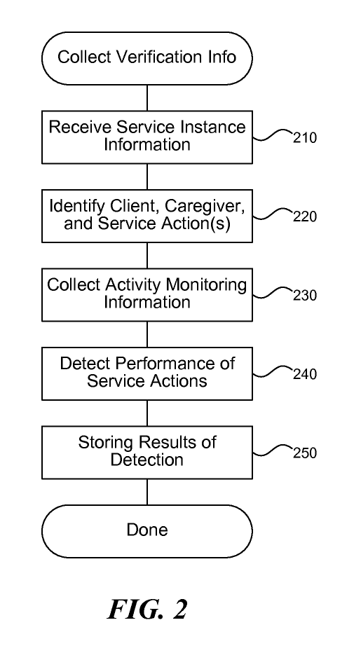

FIG. 2 is a flow diagram that illustrates processing of the health service system to receive care verification information from a mobile device associated with a caregiver, in one embodiment.

Beginning in block 210, the system receives information that defines a particular instance of a service to be performed, wherein the information identifies a particular client to receive the service, a particular caregiver to perform the service, and one or more service actions that comprise successful completion of the service. For example, the client may be identified by name and address, the caregiver by name and employee number (or other information), and the service actions by description (e.g., bathe client, prepare five meals for client, administer particular medications to the client, and so forth). A mobile device carried by the caregiver may connect to a service from which the mobile device receives the information. The caregiver may run a particular application on the mobile device, or the device may detect what the caregiver intends to do using geo-fencing based on the caregiver's location or other automated techniques. For example, the system may detect that the caregiver has arrived at a particular client's location, and may then prompt the caregiver with a list of tasks to be performed for the day.

Continuing in block 220, the system identifies the client, caregiver, and service actions received and determines activity of the caregiver to be monitored to verify that the service actions are performed. For example, if one service action is bathing a client, then the system may determine that collecting information related to a bathroom location of the client's home will verify that the activity is performed, as well as a picture of the caregiver and client together upon arrival.

Continuing in block 230, the system collects activity monitoring information from one or more sensors of the caregiver's mobile device that substantiate service actions performed by the caregiver. The information collected may include times, locations, photographic or audiovisual evidence, textual information, biometric information (e.g., a client fingerprint), or any other type of information that can be collected at the client site by the mobile device. The collection of information may occur at particular times (e.g., arrival and departure from the client site) and may also be ongoing (e.g., periodic sampling of the caregiver's location). Some information may be collected at the caregiver's request (e.g., a photo of the caregiver and client) while other information may be collected automatically without a specific request by the caregiver. The system adheres to privacy rules applicable in particular jurisdictions, and may limit the information collected without explicit authorization on this basis. In some cases, the client may be asked to provide permission for the collection of particular data.

Continuing in block 240, the system detects performance of one or more identified service actions based on the collected activity monitoring information. For example, if the system detects that a sufficient amount of time was spent in a particular sub-location within a house where a particular service action is performed, then the system may deem the action to have been performed. As another example, if the client confirms that an action was performed then the system may detect that the action was performed or may add this information to an accumulating set of information that together verifies performance of the activity.

Continuing in block 250, the system stores results of the detection of performance of actions locally on the mobile device. In some embodiments, the system uploads stored results of detection to a central service in real-time or shortly after services are performed. However, in some cases a live connection to the central service may not be readily available (such as when the caregiver and client are in a low infrastructure area). In such cases, the system may store verification information locally on the mobile device until a later time at which a live connection to the central service is available. After block 250, these steps conclude.

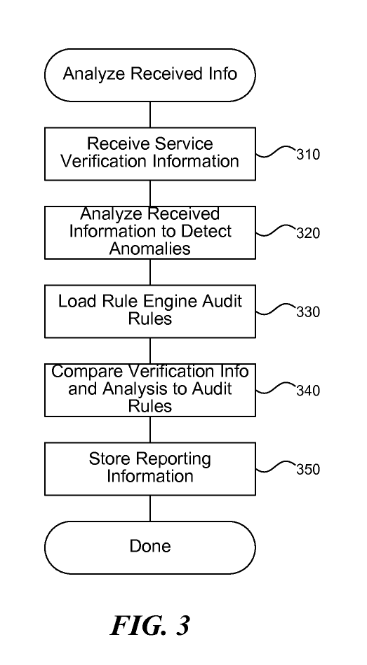

FIG. 3 is a flow diagram that illustrates processing of the health service system to analyze information at a health care service provided by one or more mobile devices associated with caregivers, in one embodiment.

Beginning in block 310, the system receives information verifying performance of one or more healthcare services from one or more mobile devices carried by caregivers. The verification information includes information of an evidentiary nature and may include automatically collected information that corroborates manually provided information. For example, location information automatically collected using GPS or other hardware may verify manually entered information related to what a caregiver was doing at a particular time.

Continuing in block 320, the system analyzes received verification information to detect anomalies in the received verification information and to identify any areas for further investigation and verification. For example, the analysis may detect inconsistencies in data collected from various sources, such as that provided by caregivers, clients, and automatically collected by devices. The analysis may also identify further information about collected data, such as identifying faces in photos, voices in audio data, drive times between locations, out of range values, and so forth. The system stores analyzed information in a verification database for further use by the system.

Continuing in block 330, the system loads one or more audit rules managed by a rules engine that stores rules related to one or more payers for healthcare services, where each rule specifies one or more types of information the receipt of which the payer requests to receive as a condition of payment. For example, rules may specify a particular requested type of time entry, service description, client identification, permissible location for services, and so forth. The system may store a database of rules received from payers from which the system can later load the rules to compare to received verification information.

Continuing in block 340, the system compares received verification information and analysis to the one or more loaded audit rules to determine whether a particular healthcare service was performed in accordance with a particular payer's rules. The system associates identified verification information and analysis with a payment request for submission to the payer or for viewing by the payer when the payer processes submissions. The verification information provides evidence to the payer that a requested service was performed and enhances the detection and prevention of fraudulent practices. The system also reduces the burden on caregivers, clients, and payers for collecting information related to healthcare services as many types of information can be collected and gathered automatically by mobile devices and computer-based services.

Continuing in block 350, the system stores reporting information based on the comparison that will indicate to the payer whether the particular healthcare service was performed in accordance with the particular payer's rules. The system may provide a report (e.g., via email or other format) to the payer with this information or the payer may periodically access a payer interface of the system to process one or more pending payment requests. For example, the system may provide a website through which payers can access the system to process payments and to view available verification information related to any requested service instance. After block 350, these steps conclude.

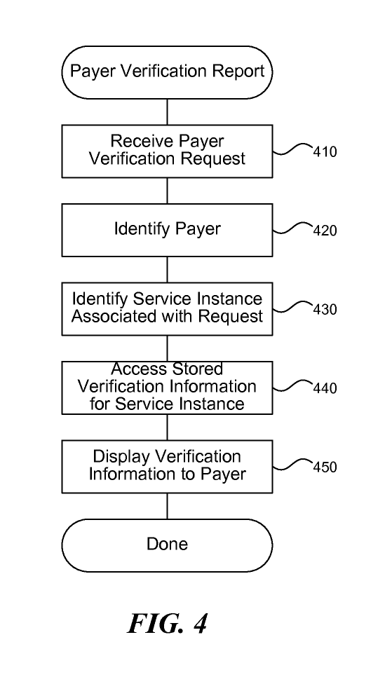

FIG. 4 is a flow diagram that illustrates processing of the health service system to provide verification to a health service payer, in one embodiment.

Beginning in block 410, the system a verification request from a payer accessing the system to determine whether a particular healthcare service was performed for a particular client to determine whether a payment for the service is due. For example, the payer may access a website or other interface of the system that provides one or more web pages or other displays that a payer can use to receive information from the system. The payer may be presented by the system with one or more pending payment requests along with any relevant verification information collected by the system at the time the related service was rendered or later analyzed from the collected data.

Continuing in block 420, the system identifies the payer associated with the request. The system may maintain a profile for each payer or for representatives of the payer, and the payer or its representatives may log in by providing an identification of the profile (e.g., a user name) and authentication information (e.g., a password or other information). Upon logging in, the system knows the identity of the payer and can provide individualized information to the payer.

Continuing in block 430, the system identifies a service instance associated with the request, where a service instance identifies a particular healthcare service provided to a particular client on a particular occasion. The instance may also identify a particular caregiver expected to or authorized to perform the service. The system may present the payer with a list of pending payment requests and associated services that the payer can review to determine whether the service was performed to a level of satisfaction of the payer and in accordance with any conditions that the payer placed upon reimbursement for the service.

Continuing in block 440, the system accesses stored verification information associated with the identified service instance. As described herein, the system may have collected verification automatically as the service was performed and may also have later analyzed received verification information to determine secondary characteristics of the information (e.g., anomalies, errors, substantiating information, and so forth). The system may provide a database or other storage facility from which the information can be accessed in response to payer requests.

Continuing in block 450, the system displays the accessed verification information to the payer as proof that the service was performed and that payment is due. The display may include sending a report to the payer, displaying a graphical user interface (GUI), providing the information programmatically to a third party or in-house tools used by the payer for processing payments, and so forth. After block 450, these steps conclude.

In some embodiments, the health service system operates to increase the percentage of caregivers, consumers, and case managers performing health data collection and/or using electronic timesheets and mileage logs, in addition to other goals described herein. The system provides a variety of services that can serve to reduce burden on users of the system to manually enter data. For example, by automatically capturing information describing a caregiver's location and activities, the system can automatically fill out a timesheet on behalf of the caregiver, and can provide that information as proof of time spent by the caregiver to other parties (e.g., payers, employers, and so forth). This reduces data entry costs, prevents fraud, decreases audit costs, and makes it easier for caregivers to submit timesheets and for clients to approve submissions. The system can provide these services via the web as well as on various computing and mobile computing devices.

In some embodiments, the health service system uses encryption and other cryptographic techniques to secure data stored and transmitted by the system. Privacy is an important concern of clients and in many cases is mandated by various legislative acts, such as the Health Insurance Portability and Accountability Act (HIPAA) in the United States. The system may provide secure logins, secure connection streams, and secure account information recovery in addition to cryptographic techniques.

In some embodiments, the health service system provides alerts by a variety of methods to users of the system under various conditions. For example, the system may provide alerts to caregivers regarding missing information in a service report, alerts to payers about pending payments, alerts to clients about upcoming appointments for services, and so forth. The system may also issue the challenges described herein as a type of alert to caregivers to which the caregivers are expected to respond in a reasonable period of time.

In some embodiments, the health service system uses collected information to provide travel guidance to caregivers. For example, the system may collect location information from a mobile device of one caregiver that indicates that traffic in a particular area is bad so that other caregivers can avoid the area or take alternate routes. The system may also be used to route a closer caregiver to a particular location for an unscheduled service or where the assigned caregiver cannot arrive to complete a scheduled service in time.

In some embodiments, the health service system exposes one or more APIs for providing access to the system and data that it collects. Payers and other parties may wish to integrate the system with existing back office system for processing payments, generating reports, and so forth. The system may also leverage APIs of other systems to pull in state rule information, personnel data for caregivers, payer audit rules, client information, collected health data, and so on. The APIs provided may include web service APIs, programmatic interfaces, or any other method of exposing functionality of the system to other systems.

From the foregoing, it will be appreciated that specific embodiments of the health service system have been described herein for purposes of illustration, but that various modifications may be made without deviating from the spirit and scope of the invention. Accordingly, the invention is not limited except as by the appended claims.

I/We claim:

1. A computer-implemented method to receive care verification information from a mobile device associated with a caregiver, the method comprising:
receiving service information that defines a particular instance of a service to be performed, wherein the service information identifies a particular client to receive the service, a particular caregiver to perform the service, and one or more service actions that comprise successful completion of the service;
identifying the client, caregiver, and service actions received and determining activity of the caregiver to be monitored to verify that the service actions are performed;
collecting activity monitoring information that substantiates service actions performed by the caregiver;
detecting performance of one or more identified service actions based on the collected activity monitoring information; and
storing results of the detection of performance of actions on a storage device associated with the caregiver,
wherein the preceding steps are performed by at least one processor.

2. The method of claim 1 wherein receiving service information comprises at least one of identifying the client by name and address, identifying the caregiver by name and employee number, and identifying the service actions by description.

3. The method of claim 1 wherein receiving service information comprises a mobile device carried by the caregiver that connects to a service from which the mobile device receives the service information.

4. The method of claim 1 wherein receiving service information comprises the caregiver running a particular application on a mobile device that collects the service information automatically.

5. The method of claim 1 wherein receiving service information comprises automatically detecting service actions that the caregiver intends to perform using geo-fencing based on the caregiver's location.

6. The method of claim 1 further comprising detecting that the caregiver has arrived at a particular client's location, and prompting the caregiver with a list of tasks to be performed for the day.

7. The method of claim 1 wherein determining activity to be monitored comprises taking a pictures of the caregiver and client together upon arrival.

8. The method of claim 1 wherein collecting activity monitoring information comprises automatically collecting information from one or more sensors of the caregiver's mobile device.

9. The method of claim 1 wherein collecting activity monitoring information comprises collecting at least one of times, locations, photographic or audiovisual evidence, textual information, and biometric information that can be collected at the client site by a mobile device.

10. The method of claim 1 wherein collecting activity monitoring information comprises collecting information at particular times including upon arrival and departure from the client site.

11. The method of claim 1 wherein collecting activity monitoring information comprises adhering to privacy rules applicable in a particular jurisdiction, and limiting the information collected without explicit authorization based on the privacy rules.

12. The method of claim 1 wherein detecting performance of service actions comprises detecting that a sufficient amount of time was spent in a particular sub-location within a house where a particular service action is performed.

13. The method of claim 1 wherein detecting performance of service actions comprises receiving confirmation from the client that an action was performed.

14. The method of claim 1 wherein storing results of detection comprises uploading stored results of detection to a central service.

15. A computer system for automated verification of delivery of healthcare services, the system comprising:
a mobile device associated with a caregiver and carried with the caregiver to a client location, the mobile device comprising:
a service interface component that communicates between the mobile device and a central service to send monitoring data captured at the mobile device to the service, and to receive information from the service for delivery to the caregiver using the mobile device;
one or more hardware sensors that sample environmental information present around the mobile device during its use, wherein the environmental information provides evidence that a particular healthcare service was performed;
a location detection component that detects a present location of the mobile device at various times based on available hardware sensors for determining location to verify a caregiver's location when a particular healthcare service is performed; and
a monitoring component that collects verification information available from the location detection component and the one or more hardware sensors and sends the information using the service interface component to the central service; and
a central service that includes one or more central servers, datacenters, or a cloud-based computing service, the central service comprising:
a device interface component that communicates with the mobile device and receives verification information from the mobile device that substantiates whether one or more healthcare services were performed, by which caregiver the services were performed, and on which client's behalf the services were performed;
a verification data store that stores verification information received from the mobile device in one or more storage device;
a rules engine that manages rules that express differences and requirements for service verification from each payer for which the system collects verification information;
a data analysis component that analyzes verification information submitted by the mobile device to identify trends and draw conclusions from the information related to verifying whether healthcare services were performed as requested;
a challenge component that provides dynamic challenges to caregivers at particular times, where a challenge represents a tool for determining whether the caregiver is in possession of a particular mobile device at a specific time; and
a dynamic trust component that dynamically determines a level of verification to request from a particular caregiver based on a historical pattern of trust established with the caregiver.

16. The system of claim 15 wherein the service interface component comprises an offline mode that allows a caregiver to use the mobile device with no real-time connectivity to the central service that to capture information that can later be transferred from the mobile device to the central service upon availability of a connection between the mobile device and central service.

17. The system of claim 15 wherein the central service provides a central location where multiple mobile devices carried by potentially many caregivers can report monitoring data related to services rendered by the caregivers to clients.

18. The system of claim 15 wherein the central service analyzes collected verification data and provides various reports available to at least one of caregivers, payers, clients, and an operator of the service.

19. The system of claim 15 wherein the rules engine includes at least one rule that identifies an entity that pays for a healthcare service and particular verification information requested by the entity as proof that a particular service was performed.

20. A computer-readable storage medium comprising instructions for controlling a computer system to analyze information at a health care service provided by one or more mobile devices associated with caregivers, wherein the instructions, upon execution, cause a processor to perform actions comprising:
receiving information verifying performance of one or more healthcare services from one or more mobile devices carried by caregivers;
analyzing received verification information to detect anomalies in the received verification information and to identify any areas for further investigation and verification;
loading one or more audit rules managed by a rules engine that stores rules related to one or more payers for healthcare services, wherein each rule specifies one or more types of information the receipt of which the payer requests to receive as a condition of payment;
comparing received verification information and analysis results to the one or more loaded audit rules to determine whether a particular healthcare service was performed in accordance with a particular payer's rules; and
storing reporting information based on the comparison that will indicate to the payer whether the particular healthcare service was performed in accordance with the particular payer's rules.
